(19) United States
(12) Patent Application Publication
(10) Pub. No.: US 2016/0373529 A1
(43) Pub. Date: Dec. 22, 2016

(54) ELECTRIC APPARATUS MANAGEMENT METHOD, MANAGEMENT APPARATUS, AND ELECTRIC APPARATUS MANAGEMENT PROGRAM

(71) Applicant: PANASONIC INTELLECTUAL PROPERTY MANAGEMENT CO., LTD., Osaka (JP)

(72) Inventors: TATSUYA MORISHITA, Shiga (JP); MASAKI HAYASHI, Osaka (JP); HIROKI NISHIDA, Kyoto (JP); HIROMI TOYOTA, Kyoto (JP); YOSHIYUKI INOUE, Kyoto (JP)

(21) Appl. No.: 15/122,156

(22) PCT Filed: Apr. 3, 2015
(86) PCT No.: PCT/JP2015/001902

§ 371 Date: Aug. 26, 2016

(30) Foreign Application Priority Data
Apr. 4, 2014 (JP) 2014-077496
May 13, 2014 (JP) 2014-099288

(51) Int. Cl. H04L 29/08

(52) U.S. Cl. CPC H04L 67/125; H04L 67/10

(57) ABSTRACT

A method for managing an electric apparatus includes a step of obtaining first control item information for controlling a first electric apparatus, from the first management server that manages the first electric apparatus; a step of obtaining second control item information for controlling a second electric apparatus, from a second management server that manages the second electric apparatus different from the first electric apparatus; and a step of providing information relating to the first control item information and the second control item information to a user terminal. In addition, the method includes a step of receiving control information relating to the first electric apparatus and the second electric apparatus, from the user terminal; and a step of transmitting the control item information corresponding to the control information received from the user terminal, of the first control item information and the second control item information, to any one of the first management server and the second management server in which the control item information is obtained.

### TECHNICAL FIELD

The present invention relates to a method of managing an electric apparatus, a management apparatus, and a program for managing the electric apparatus, capable of remotely controlling the electric apparatus through a network.

### BACKGROUND ART

In the related art, a system of managing an electric apparatus, which controls the electric apparatus through a network is proposed (for example, see Japanese Patent Unexamined Publication No. 2011-123704).

In the system of managing the electric apparatus in Japanese Patent Unexamined Publication No. 2011-123704, an integrated management server is communicated with a first part management server that manages a security apparatus and a second part management server that manages a lighting apparatus, through a network. With this, the integrated management server obtains control information of the security apparatus and the lighting apparatus within the user's home. A user controls the security apparatus and the lighting apparatus, by accessing the integrated management server, within the user's home.

In this manner, it is possible for users to remotely control the security apparatus and the lighting apparatus within the user's home, through the first part management server and the second part management server.

However, in Japanese Patent Unexamined Publication No. 2011-123704 described above, the integrated management server obtains information of a control command of the electric apparatus. Therefore, there are issues of safety management of an operation of the electric apparatus that a maker of the electric apparatus has to disclose the control command of the electric apparatus to an operator of the integrated management server, and thus the control command is leaked, and the like.

### CITATION LIST

### Patent Literature

PTL 1: Japanese Patent Unexamined Publication No. 2011-123704.

### SUMMARY OF THE INVENTION

The present invention implemented in view of the problem of the related art described above is to provide a method of managing an electric apparatus, a management apparatus, and a program for managing the electric apparatus, capable of reducing the risk of control command leakage, without providing a control command to a server.

According to an aspect of the present invention, there is provided a method for managing an electric apparatus including a step of obtaining first control item information for controlling a first electric apparatus, from a first management server that manages the first electric apparatus; a step of obtaining second control item information for controlling a second electric apparatus, from a second management server that manages the second electric apparatus different from the first electric apparatus; and a step of providing information relating to the first control item information and the second control item information to a user terminal. The method includes a step of receiving control information relating to the first electric apparatus and the second electric apparatus, from the user terminal; and a step of transmitting the control item information corresponding to the control information received from the user terminal, of the first control item information and the second control item information, to any one of the first management server and the second management server in which the control item information is obtained.

With this, it is possible to reduce the risk of leakage of the control command, without providing the control command to the management apparatus of an integrated server or the like, in a control system of the electric apparatus. Even in a case where each of a plurality of electric apparatuses is managed by another management server, the user can simply operate the plurality of electric apparatuses by accessing the integrated server.

According to another aspect of the present invention, there is provided a method for managing the electric apparatus including a step of obtaining first control item information for controlling a first electric apparatus, from a first management server that manages the first electric apparatus; a step of providing information relating to the first control item information to a user terminal; and a step of receiving control information relating to control item information including the first control item information from the user terminal. The method includes a step of transmitting the control information to the first management server, in a case where a control item corresponding to the control information received from the user terminal is the first control item information, among the first control item information.

With this, since a part of the control command is provided to the management apparatus of the integrated server or the like, it is possible for the integrated server to transmit the control command to the electric apparatus without going through the management server. Since another control command is not provided to the integrated server, it is possible to improve the safety of the electric apparatus.

The management apparatus of the present invention includes a communicator that obtains first control item information for controlling a first electric apparatus, from a first management server that manages the first electric apparatus, and obtains second control item information for controlling a second electric apparatus, from a second management server that manages the second electric apparatus different from the first electric apparatus. The communicator provides information relating to the first control item information and the second control item information to a user terminal, and receives control information relating to the first electric apparatus and the second electric apparatus from the user terminal. The management apparatus includes a processor that controls the communicator, and selects control item information corresponding to the control information received from the user terminal, of the first control item information and the second control item information. The communicator transmits the control item information corresponding to the control information, to any one of the first management server and the second management server in which the control item information is obtained.

With this, in the control system of the electric apparatus in which the management apparatus is provided, it is possible to reduce the risk of the leakage of the control command, without providing the control command to the management apparatus of the integrated server or the like. Even in a case where each of a plurality of electric apparatuses is managed by another management server, the user can simply operate the plurality of electric apparatuses by accessing the integrated server.

According to still another aspect of the present invention, there is provided a management apparatus including a communicator that obtains first control item information for controlling a first electric apparatus, from a first management server that manages the first electric apparatus, provides information relating to the first control item information to a user terminal, and receives control information relating to control item information including the first control item information from the user terminal. The management apparatus includes a controller that controls the communicator, and confirms whether a control item corresponding to the control information received from the user terminal is the first control item information, among the first control item information. In a case where the control item corresponding to the control information is the first control item information, the communicator transmits the control information to the first management server.

With this, since a part of the control command is provided to the management apparatus of the integrated server or the like, it is possible for the integrated server to transmit the control command to the electric apparatus, without going through the management server. Since another control command is not provided to the integrated server, it is possible to improve the safety of the electric apparatus.

According to still further aspect of the present invention, there is provided a program for managing an electric apparatus, causing a computer to execute a step of obtaining first control item information for controlling a first electric apparatus, from a first management server that manages the first electric apparatus; a step of obtaining second control item information for controlling a second electric apparatus, from a second management server that manages the second electric apparatus different from the first electric apparatus; and a step of providing information relating to the first control item information and the second control item information to a user terminal. The program causes a computer to execute a step of receiving control information relating to the first electric apparatus and the second electric apparatus, from the user terminal; and a step of transmitting control item information corresponding to the control information received from the user terminal, of the first control item information and the second control item information, to any one of the first management server and the second management server in which the control item information is obtained.

With this, in the control system of the electric apparatus including the management apparatus in which the management program is loaded, it is possible to reduce the risk of the leakage of the control command without providing the control command to the management apparatus of the integrated server or the like. Even in a case where each of a plurality of electric apparatuses is managed by another management server, the user can simply operate the plurality of electric apparatuses by accessing the integrated server.

According to still further another aspect of the present invention, there is provided a program for managing an electric apparatus, causing a computer to execute a step of obtaining first control item information for controlling a first electric apparatus, from a first management server that manages the first electric apparatus; a step of providing information relating to the first control item information to a user terminal; and a step of receiving control information relating to control item information including the first control item information from the user terminal. The program causes a computer to execute a step of transmitting the control information to the first management server, in a case where a control item corresponding to the control information received from the user terminal is the first control item information, among the first control item information.

With this, since a part of the control command is provided to the management apparatus of the integrated server or the like, it is possible for the integrated server to transmit the control command to the electric apparatus without going through the management server. Since other control commands are not provided to the integrated server, it is possible to improve the safety of the electric apparatus.

As described above, according to the method for managing the electric apparatus, the management apparatus, and the program for managing the electric apparatus of the present invention, the management server provides the control item to the management apparatus of the integrated server or the like, and does not provide at least a part of the control command. With this, it is possible to improve the safety of the electric apparatus.

### BRIEF DESCRIPTION OF DRAWINGS

FIG. 1 is a diagram illustrating a configuration of a control system for controlling an electric apparatus, in a first exemplary embodiment of the present invention.

FIG. 2 is a diagram illustrating an example of a hardware configuration of an integrated server, in the first exemplary embodiment of the present invention.

FIG. 3 is a flowchart illustrating a processing flow of the integrated server, in the first exemplary embodiment of the present invention.

FIG. 4 is a diagram illustrating an example of control items for controlling an electric apparatus that is an air conditioner, in the first exemplary embodiment of the present invention.

FIG. 5 is a diagram illustrating an example of the control items for controlling the electric apparatus that is the air conditioner, in the first exemplary embodiment of the present invention.

FIG. 6 is a diagram illustrating an example of control items for controlling an electric apparatus that is a television, in the first exemplary embodiment of the present invention.

FIG. 7 is a diagram illustrating an example of a relationship between the electric apparatus and the control items, which is provided to a user terminal, in the first exemplary embodiment of the present invention.

FIG. 8 is a diagram illustrating an example of a display screen of a user terminal displaying a list representing the electric apparatus and the control items, in the first exemplary embodiment of the present invention.

FIG. 9 is a diagram illustrating another example of the display screen of the user terminal displaying the list representing the electric apparatus and the control items, in the first exemplary embodiment of the present invention.

FIG. 10 is a diagram illustrating an example of a screen for inputting details of the control items such as a temperature to be set, in the first exemplary embodiment of the present invention.

FIG. 11 is a diagram illustrating an example of parameters representing details of control of control information, in the first exemplary embodiment of the present invention.

FIG. 12 is a diagram illustrating an example of a series of sequences for controlling the electric apparatus, through the integrated server and a management server, by using the user terminal, in the first exemplary embodiment of the present invention.

FIG. 13 is a diagram illustrating an example of a hardware configuration of the user terminal, in the first exemplary embodiment of the present invention.

FIG. 14 is a flowchart illustrating a processing flow in the user terminal, in the first exemplary embodiment of the present invention.

FIG. 15 is a diagram illustrating an example of a hardware configuration of the management server, in the first exemplary embodiment of the present invention.

FIG. 16 is a flowchart illustrating a processing flow in the management server, in the first exemplary embodiment of the present invention.

FIG. 17 is a diagram illustrating an example of a correspondence table of the control information and control commands, relating to the electric apparatus, in the first exemplary embodiment of the present invention.

FIG. 18 is a diagram illustrating an example of a correspondence table of the control information and control commands, relating to the electric apparatus, in the first exemplary embodiment of the present invention.

FIG. 19 is a flowchart illustrating a processing flow in an integrated server, in a second exemplary embodiment of the present invention.

FIG. 20 is a diagram illustrating an example of a list representing control items for controlling an electric apparatus and control commands corresponding to standard items, in the second exemplary embodiment of the present invention.

FIG. 21 is a diagram illustrating an example of a list representing the control items for controlling the electric apparatus and the control commands corresponding to the standard items, in the second exemplary embodiment of the present invention.

FIG. 22 is a diagram illustrating an example of a series of sequences for controlling the electric apparatus, through an integrated server and a management server, by using a user terminal, in the second exemplary embodiment of the present invention.

FIG. 23 is a diagram illustrating an example of a series of sequences for controlling the electric apparatus, through a repeater and the management server, by using the user terminal, in the first exemplary embodiment of the present invention.

FIG. 24 is a diagram illustrating an example of a series of sequences for controlling the electric apparatus, through the repeater and the management server, by using the user terminal, in the second exemplary embodiment of the present invention.

### DESCRIPTION OF EMBODIMENTS

Hereinafter, the exemplary embodiments of the present invention will be described with reference to drawings. The present invention is not limited by these exemplary embodiments.

### First Exemplary Embodiment

First, a first exemplary embodiment of the present invention will be described.

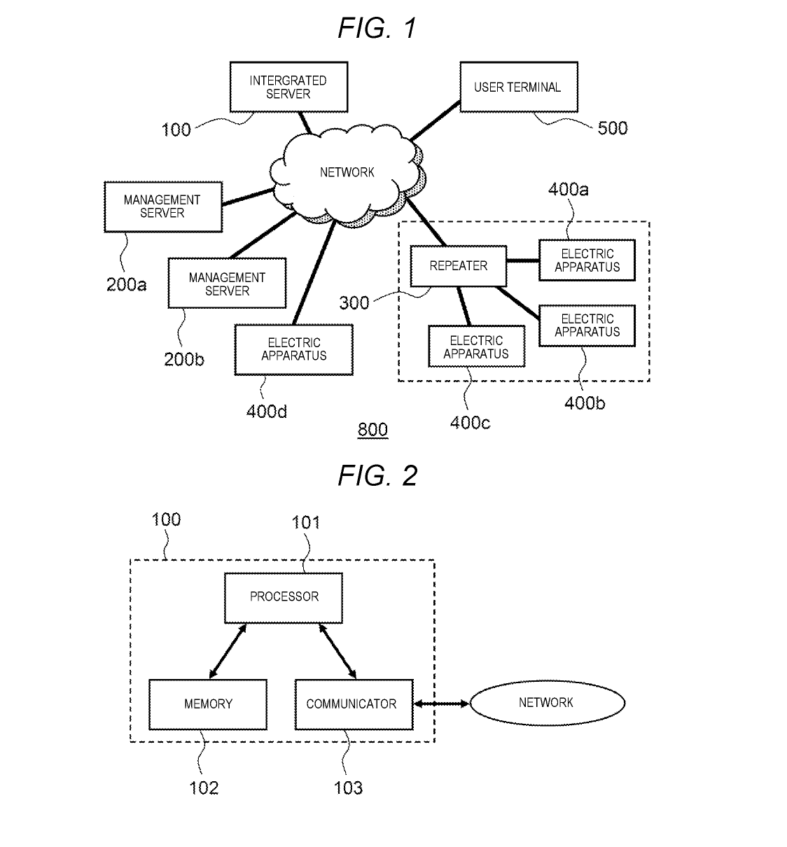

FIG. 1 is a diagram illustrating a configuration of control system 800 for controlling an electric apparatus, in the first exemplary embodiment of the present invention.

Control system 800 of the exemplary embodiment includes integrated server 100, management servers 200 (200a and 200b), user terminal 500, electric apparatuses 400 (400a, 400b, 400c, and 400d).

Integrated server 100 is connected to user terminal 500 through a network, and communicates information for controlling electric apparatus 400 with user terminal 500. Management server 200 is connected to electric apparatus 400 through the network, collects data from electric apparatus 400, or transmits a control signal with respect to electric apparatus 400.

In addition, management server 200 is connected to integrated server 100 through the network, and communicates information for managing and controlling electric apparatus 400 with integrated server 100. For example, user terminal 500 is a computer terminal used by a user, and includes a personal computer or a smart phone.

Electric apparatus 400 transmits data detected by various sensors included in electric apparatus 400 and data of an operation state and an operation log or the like of electric apparatus 400 to management server 200. Electric apparatus 400 receives the control signal from management server 200 or integrated server 100, and performs an operation corresponding to the received control signal. Electric apparatus 400 may be directly connected to the network, and, as illustrated in FIG. 1, may be connected to the network through repeater 300.

Here, management server 200a manages electric apparatus 400a and electric apparatus 400b, and management server 200b manages electric apparatus 400c. In addition, an example where electric apparatus 400a and electric apparatus 400c are used as an air conditioner, and electric apparatus 400b is used as a television is described. Electric apparatus 400 is not limited to the air conditioner and the television, may be a washing machine or a refrigerator, and may be cooking appliances such as a rice cooker, an over, and the like. In addition, electric apparatus 400 may be a dishwasher, may be an audio device, may be a hot water storage device, and may be a lighting device. Electric apparatus 400 may be any device if a device that uses electricity, and may be an electric vehicle or the like, without limiting to the household electrical appliances described above.

FIG. 2 is a diagram illustrating an example of a hardware configuration of integrated server 100, in the first exemplary embodiment of the present invention.

Integrated server 100 includes processor 101, memory 102, and communicator 103.

Processor 101, for example, is a processor of CPU or the like. Processor 101 is connected to memory 102. Processor 101 is connected to the network through communicator 103, and communicates with management server 200, user terminal 500, or electric apparatus 400, through the network. Communicator 103 includes a receiving part and a transmitting part. The receiving part receives signals from management server 200, user terminal 500, or repeater 300, and the transmitting part transmits signals to management server 200, user terminal 500, or repeater 300. The communication by communicator 103 may be wireless communication, or may be wired communication. For example, memory 102 is a memory device. Programs and data used in processor 101 are stored in memory 102. Processing of integrated server 100 described below is realized by executing programs stored in memory 102 in processor 101.

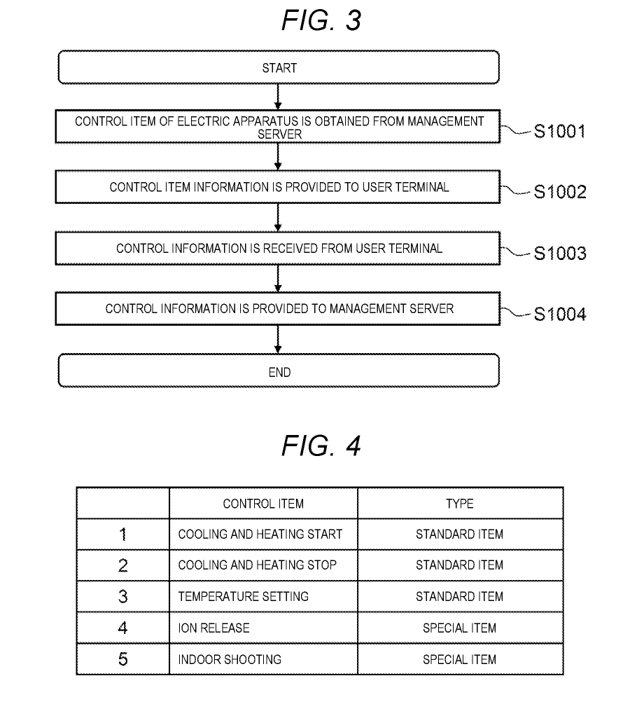

FIG. 3 is a flowchart illustrating a processing flow of integrated server 100, in the first exemplary embodiment of the present invention.

Processing of integrated server 100 will be described by using FIG. 3.

Integrated server 100 obtains each of the control items of electric apparatus 400a and electric apparatus 400b, from management server 200a, and obtains the control items of electric apparatus 400c from management server 200b (S1001).

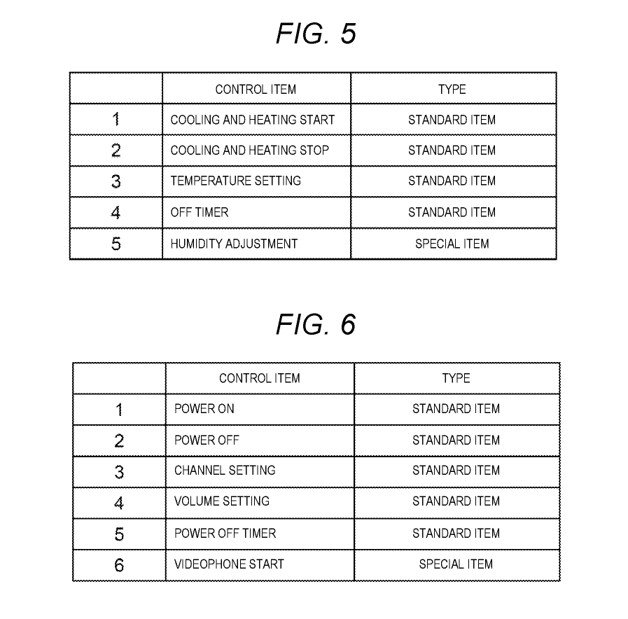

FIG. 4 is a diagram illustrating an example of the control items for controlling electric apparatus 400a that is an air conditioner, in the first exemplary embodiment of the present invention. In addition, FIG. 5 is a diagram illustrating an example of the control items for controlling electric apparatus 400c that is an air conditioner, in the same exemplary embodiment. FIG. 6 is a diagram illustrating an example of the control items for controlling electric apparatus 400b that is a television, in the same exemplary embodiment.

A “type” of the control items illustrated in FIG. 4, FIG. 5, and FIG. 6 is not an essential element. Since the description of the type of the control items not used in the exemplary embodiment will be omitted, and will be described in the second exemplary embodiment.

Returning to FIG. 3, integrated server 100 provides the obtained control items from management server 200 to user terminal 500 (S1002).

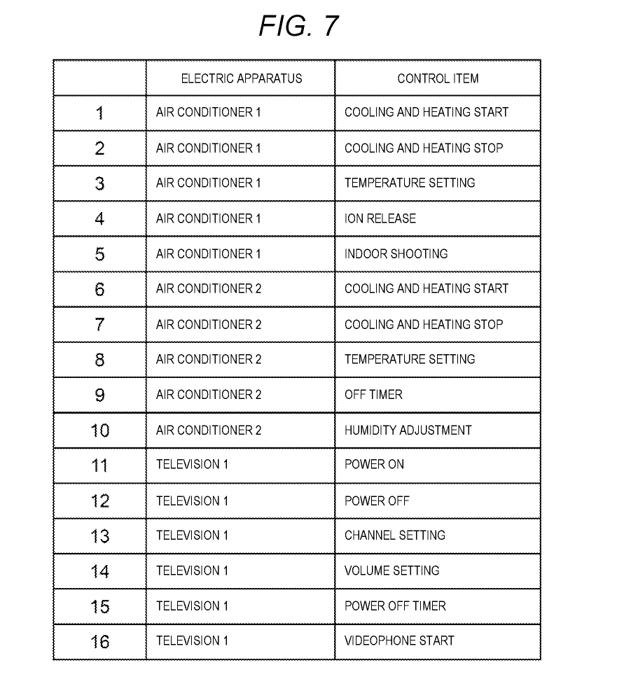

FIG. 7 is a diagram illustrating an example of a relationship between the electric apparatus and the control items provided to user terminal 500, in the first exemplary embodiment of the present invention.

In FIG. 7, electric apparatus 400a is illustrated as “air conditioner 1”, electric apparatus 400c is illustrated as “air conditioner 2”, and electric apparatus 400b is illustrated as “television 1”. Instead of information of the list, information of a type of screen information to be displayed on a display device may be provided to user terminal 500.

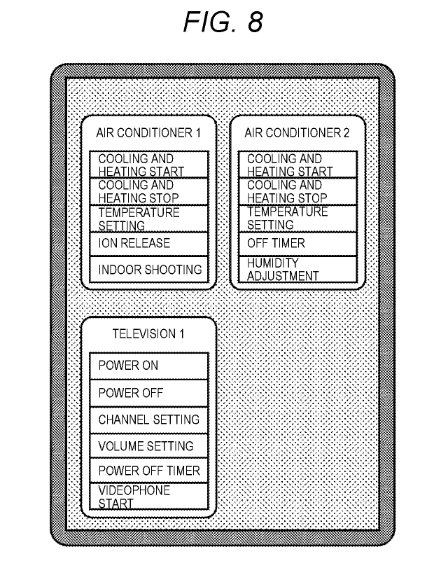

FIG. 8 is a diagram illustrating an example of the display screen of user terminal 500, illustrating a list representing electric apparatus 400 and the control items, in the first exemplary embodiment of the present invention.

In the example of FIG. 8, a list of the control items for each of the electric apparatus is illustrated.

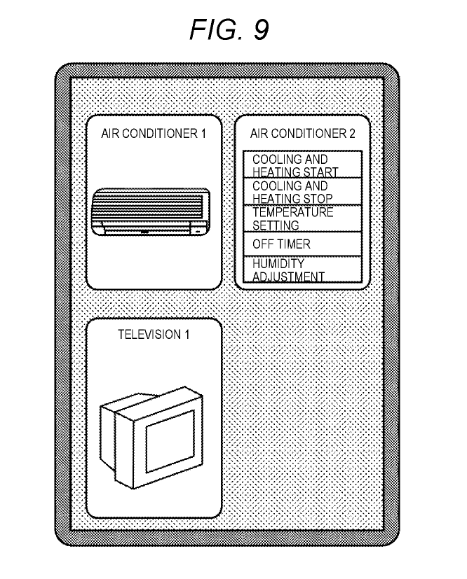

In addition, FIG. 9 is a diagram illustrating another example of the display screen of user terminal 500, illustrating a list representing electric apparatus 400 and the control items, in the first exemplary embodiment of the present invention.

In the example of FIG. 9, first, an icon representing electric apparatus 400 is displayed so as to be displayed as “air conditioner 1” and “television 1”. Next, a user selects electric apparatus 400, and when a selection operation is performed by tapping or the like an icon representing electric apparatus 400, the control item of selected electric apparatus 400 is displayed. In FIG. 9, an example of a screen in which “air conditioner 2” is selected by a user and the control item of the selected “air conditioner 2” is displayed, is displayed.

In this manner, the user operates user terminal 500 such that the control items can be selected. In the course of selecting the control items, a configuration in which the user can designate parameters relating to details of control may be implemented. For example, as illustrated in FIG. 9, when a user selects the control items of “temperature setting”, a configuration in which a screen receiving detail of temperature or the like to be set is displayed, may be implemented.

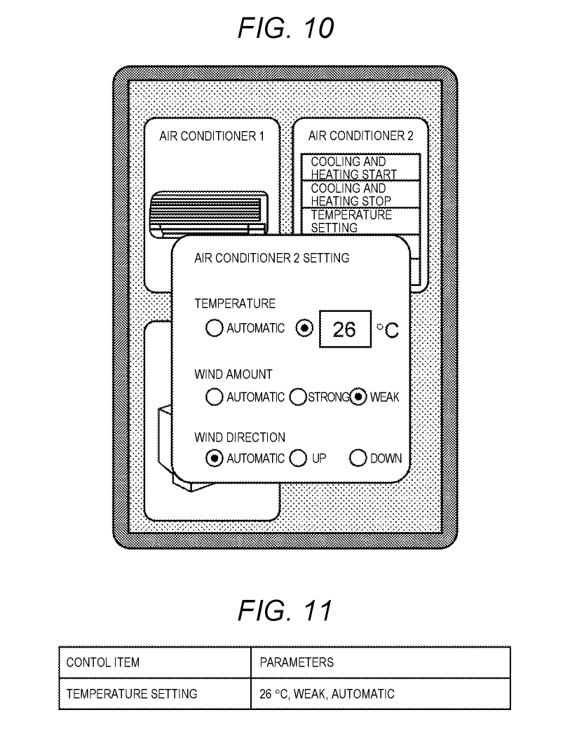

FIG. 10 is a diagram illustrating an example of a screen for inputting details of the control items such as temperature to be set, in the first exemplary embodiment of the present invention.

In FIG. 10, an input is formed so as to set temperature to “26° C.”, a wind volume to “weak”, and a wind direction to “automatic”. Here, an example is displayed by overlapping on an original screen. However, the present invention is not limited thereto.

Returning to FIG. 3, integrated server 100 receives the control information including the control items selected by a user from user terminal 500 (S1003). The control information may include parameters or the like relating to details of control.

FIG. 11 is a diagram illustrating an example of parameters representing the details of control of the control information, in the first exemplary embodiment of the present invention.

Here, an example of parameter of a case where the temperature is set to “26° C.”, the wind volume to “weak”, and the wind direction to “automatic” illustrated in FIG. 10, is displayed.

Next, integrated server 100 provides the received control information, to management server 200 for managing electric apparatus 400 corresponding to the received control information (S1004).

For example, if the received control information is the control information that “cooling and heating start” for “air conditioner 1”, the control information of “cooling and heating start” is provided with respect to management server 200a for managing electric apparatus 400a representing “air conditioner 1”. In addition, if the received control information is the control information that “temperature setting” for “air conditioner 2”, the control information of “temperature setting” is provided with respect to management server 200b for managing electric apparatus 400c representing “air conditioner 2”.

Integrated server 100 may generate information relating to control, based on the received control information, and provide the generated information to management server 200.

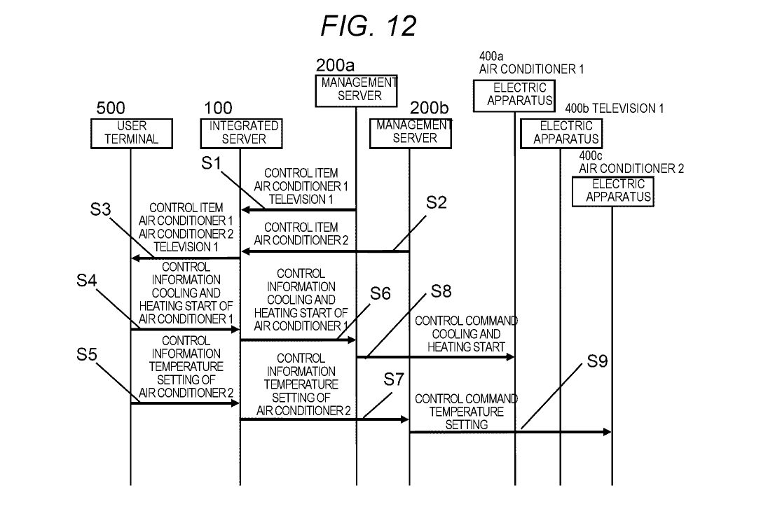

FIG. 12 is a diagram illustrating an example of a series of sequences for controlling electric apparatus 400, through integrated server 100 and management server 200, by using user terminal 500, in the first exemplary embodiment of the present invention.

Integrated server 100 obtains the control items of electric apparatuses 400 (400a, 400b, and 400c), from management servers 200 (200a and 200b) (51 and S2), and provides the obtained control items to user terminal 500 (S3).

Integrated server 100 receives the control information from user terminal 500 (S4 and S5), and provides the received control information to management server 200 for managing electric apparatus 400 corresponding to the received control information (S6 and S7). Here, the control information provided to management server 200 may be mutually recognized in integrated server 100 and management server 200, and not necessary to be recognized by electric apparatus 400. Management server 200 creates a control command to be recognized by electric apparatus 400 from the received control information. Management server 200 transmits the control command to electric apparatus 400 managed by itself, and performs a control corresponding to electric apparatus 400 (S8 and S9).

Integrated server 100 is described as to obtain the control items from management server 200 through the network. However, the present invention is not limited thereto. Integrated server 100 may obtain the control items, through a memory medium such as a USB memory device, an SD card, and the like.

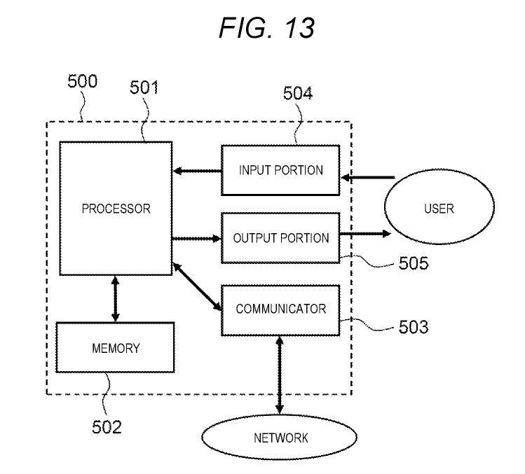

FIG. 13 is a diagram illustrating an example of a hardware configuration of user terminal 500, in the first exemplary embodiment of the present invention.

User terminal 500 includes processor 501, memory 502, communicator 503, input portion 504, and output portion 505.

For example, processor 501 is a processor of the CPU or the like. Processor 501 is connected to memory 502. Processor 501 is connected to the network through communicator 503, and communicates with integrated server 100 through the network. Preferably, communication by communicator 503 is wireless communication in the convenience of the user. However, the communication may be wired communication.

For example, memory 502 is a memory device. Programs and data used in processor 201 are stored in memory 502. By executing the program stored in memory 502 in processor 201, processing of user terminal 500 described below is performed.

Input portion 504 is a device for receiving an operation or the like of a user, and can use a switch, a key, a touch panel, or the like. Input portion 504 may be a microphone or the like for receiving audio. Information input to input portion 504 is transmitted to processor 501. Output portion 505 is a device for outputting information toward users or the like, and a display device such as an LED monitor and the like. Output portion 505 may be a speaker or the like for outputting audio.

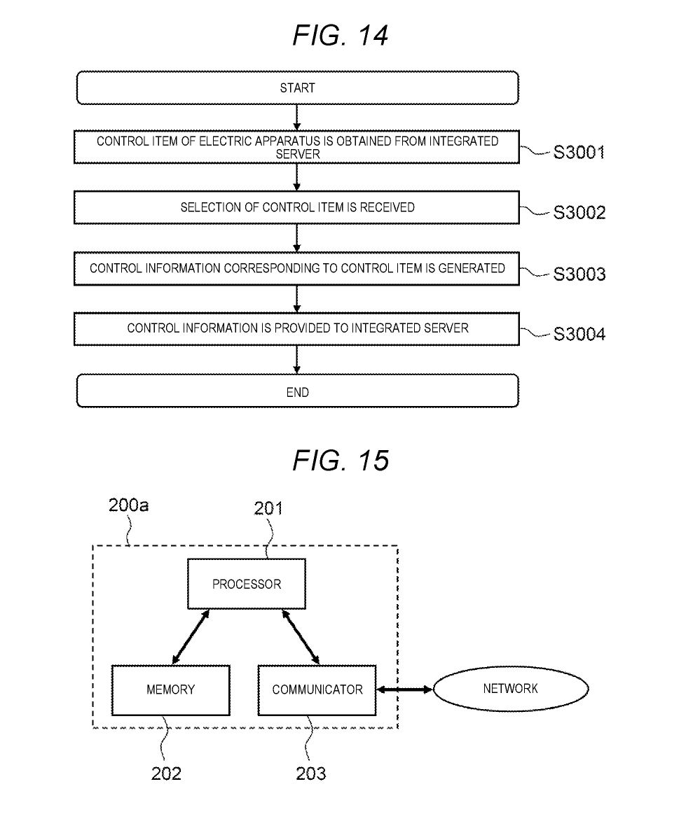

FIG. 14 is a flowchart illustrating a processing flow of user terminal 500, in the first exemplary embodiment of the present invention.

By using FIG. 14, processing of user terminal 500 will be described.

User terminal 500 obtains the control items of electric apparatus 400 from integrated server 100 (S3001). User terminal 500 notifies a user of the control items, through output portion 505. For example, the control information is displayed on a display device. The control information may be output from the speaker as audio.

User terminal 500 receives selection of the control items by an operation of a user, through input portion 504 (S3002). User terminal 500 generates the control information corresponding to the received control items (S3003). User terminal 500 provides the generated control information to integrated server 100 (S3004).

FIG. 15 is a diagram illustrating an example of a hardware configuration of management server 200, in the first exemplary embodiment of the present invention.

In FIG. 15, management server 200a is illustrated. However, management server 200b also has the same configuration. The management server includes processor 201, memory 202, and communicator 203.

Processor 201, for example, is a processor of CPU or the like. Processor 201 is connected to memory 202. Processor 201 is connected to the network through communicator 203, and communicates with integrated server 100 or electric apparatus 400 through the network. Communication by communicator 203 may be wireless communication, or may be wired communication. For example, memory 202 is a memory device. Programs and data used in processor 201 are stored in memory 202. By executing programs stored in memory 202 in processor 201, processing of management server 200 described below is executed.

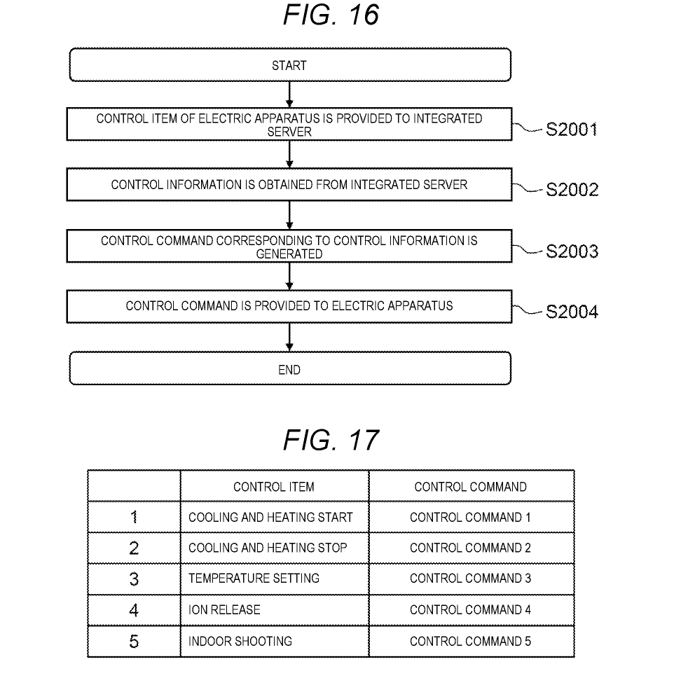

FIG. 16 is a flowchart illustrating a processing flow in management server 200, in the first exemplary embodiment of the present invention.

By using FIG. 16, processing in management server 200 will be described.

Management server 200a provides the control items of electric apparatus 400a and electric apparatus 400b to integrated server 100. Management server 200b provides the control items of electric apparatus 400c to integrated server 100 (S2001).

Management server 200 obtains the control information corresponding to the control items selected by a user by using user terminal 500 from integrated server 100 (S2002).

At this time, the control information obtained by management server 200a is the control information corresponding to electric apparatus 400a and electric apparatus 400b managed by management server 200a. In addition, the control information obtained by management server 200b is the control information corresponding to electric apparatus 400c managed by management server 200b.

Management server 200 generates the control command corresponding to the obtained control information (S2003).

Here, the control command can be recognized by electric apparatus 400. For example, the control command may be converted into a command which can be recognized by electric apparatus 400, by another device such as repeater 300 or the like.

FIG. 17 is a diagram illustrating an example of a correspondence table of the control information and the control command, relating to electric apparatus 400a, in the first exemplary embodiment of the present invention.

Management server 200a generates the control command of electric apparatus 400a from the control information obtained from integrated server 100, based on the correspondence illustrated in FIG. 17.

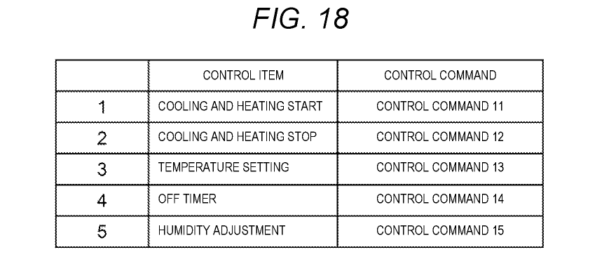

FIG. 18 is a diagram illustrating an example of a correspondence table of the control information and the control command, relating to electric apparatus 400c, in the first exemplary embodiment of the present invention.

Management server 200b generates the control command of electric apparatus 400c from the control information obtained from integrated server 100, based on correspondence illustrated in FIG. 18.

Returning to FIG. 16, management server 200 provides the generated control command to electric apparatus 400 (S2004). For example, when the control information of “cooling and heating start” for “air conditioner 1” is obtained from integrated server 100, management server 200a generates “control command 1”, and transmits “generated control command 1” to electric apparatus 400a. In addition, when the control information of “temperature setting” for “air conditioner 2” is obtained from integrated server 100, management server 200b generates “control command 13”, and transmits generated “control command 13” to electric apparatus 400c.

As described above, in control system 800 of the electric apparatus according to the exemplary embodiment, the control command recognized by electric apparatus 400 is shared between management server 200 and electric apparatus 400. However, the control command is not supplied to integrated server 100. With this, it is possible to reduce the risk of leakage of the control command. Accordingly, it is possible to avoid a dangerous control by a malicious control command or the like. In addition, even in a case where each of a plurality of the electric apparatuses is managed by another management server 200, it is possible for a user to simply operate a plurality of electric apparatuses 400, by accessing integrated server 100.

### Second Exemplary Embodiment

Next, a second exemplary embodiment of the present invention will be described.

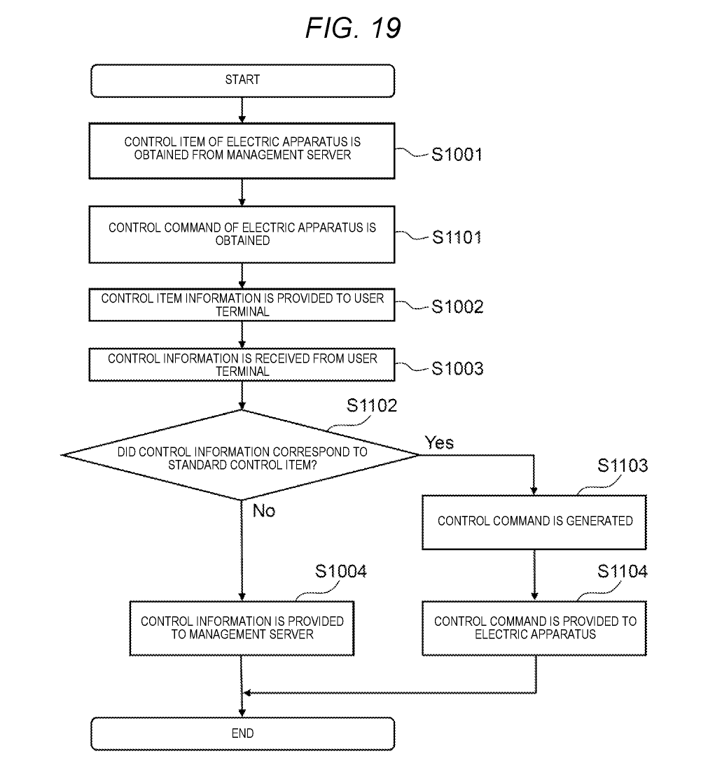

FIG. 19 is a flowchart illustrating a processing flow in integrated server 100, in the second exemplary embodiment of the present invention.

By using FIG. 19, processing in integrated server 100 will be described. The same reference numerals are given in the same processing as the processing flow of the first exemplary embodiment, and description of a part is omitted.

Integrated server 100 obtains the control items of electric apparatus 400a and electric apparatus 400b from management server 200a, and obtains the control items of electric apparatus 400c from management server 200b (S1001).

As illustrated in FIG. 4, FIG. 5, and FIG. 6, the “standard items” and “special items” are included in a “type” of the control items. Here, “the standard items” are items for performing control of a standard function in electric apparatus 400 of a type, for each type of electric apparatus 400. In addition, the “special items” are items for performing control of a special function, not the standard function in electric apparatus 400 of a type, for each type of electric apparatus 400.

For example, if electric apparatus 400 is the “air conditioner”, “start of cooling and heating” and “stop”, “setting of temperature”, or the like is the standard item, and “humidity adjustment”, “ion release”, or the like is the special item. If the electric apparatus is the “television”, “on” and “off” of the power source, “setting of a channel”, or the like is the standard item, and “start of television phone” or the like is the special item.

In addition, a common item regardless of makers of electric apparatus 400 may be set as the standard items, and a unique item for each maker of electric apparatus 400 may be set as the special item.

In addition, the standard items may be set as a predetermined item, and other items may be set as the special item. If electric apparatus 400 has a standard function, it is not necessary that electric apparatus 400 corresponds to the standard function, and there may be electric apparatus 400 that does not correspond to a part of the standard items.

In addition, for example, an item having an object detail specification in the ECHONET Lite (registered trademark) standard may be set as the standard items, and an item not having the object detail specification may be set as the special item. Alternately, an item defined as “essential” in the object detail specification in the ECHONET Lite may be set as the standard items, and other items are may be set as the special item. Matter of course, a communication standard is not limited to the ECHONET Lite. Another communication standard such as AllJoin or the like may be used.

Returning to FIG. 19, integrated server 100 obtains the control command corresponding to the standard items among the control items of electric apparatus 400 (S1101). The control command may be obtained from management server 200 through the network, and may be obtained through a recording medium. In addition, the control command is not necessarily obtained from management server 200, may be obtained from another database, and may be previously stored in memory 102 of integrated server 100.

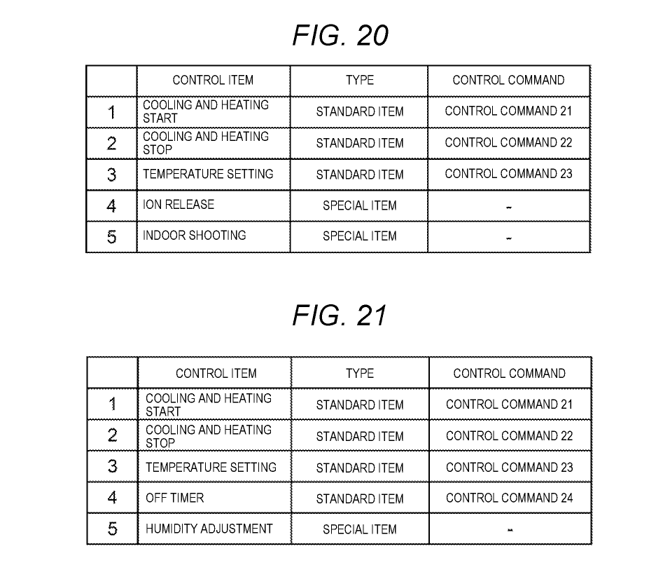

FIG. 20 is a diagram illustrating an example of a list representing the control items for controlling electric apparatus 400a and the control command corresponding to standard items, in the second exemplary embodiment of the present invention. In addition, FIG. 21 is a diagram illustrating an example of a list representing the control items for controlling electric apparatus 400c and the control commands corresponding to the standard items, in the same exemplary embodiment.

In the exemplary embodiment, the control command corresponding to the special item is not provided to integrated server 100. On the contrary, the control item in which the control command corresponding to the control item is provided to integrated server 100 may be treated as the standard item, and the control item in which the control command corresponding to the control item is not provided to integrated server 100 may be treated as the special item. In addition, the control item in which corresponding control command is previously obtained by integrated server 100 may be treated as the standard item, and the control item in which corresponding control command is not previously obtained by integrated server 100 may be treated as the special item.

Returning to FIG. 19, integrated server 100 provides the control items to user terminal 500 (S1002), and receives the control items selected by a user from user terminal 500 (S1003).

Integrated server 100 determines whether the received control information is the control information corresponding to the standard items or the control information corresponding to the special item (S1102). In a case where the control information corresponds to the special item (S1102, NO), the control information corresponding to the received control information is provided to management server 200 for managing the electric apparatus corresponding to the received control information (S1004).

Meanwhile, in a case where the control information corresponds to the standard items (S1102, YES), integrated server 100 generates the control command corresponding to the received control information (S1103), and provides the generated control command to electric apparatus 400 corresponding to the received control information (S1104).

For example, it is assumed that the received control information is “cooling and heating start” with respect to “air conditioner 1”. Since the “cooling and heating start” with respect to the air conditioner corresponds to the standard items, integrated server 100 provides “control command 21” corresponding to the “cooling and heating start” to electric apparatus 400a represented as “air conditioner 1”. In addition, for example, it is assumed that the received control information is “humidity adjustment” with respect to “air conditioner 2”. Since the “humidity adjustment” with respect to the air conditioner is the special item, integrated server 100 provides the control information corresponding to the “humidity adjustment” with respect to the “air conditioner 2”, to management server 200b for managing electric apparatus 400c represented as “air conditioner 2”.

In addition, for example, it is assumed that the received control information is “videophone start” for “television 1”. Since the “videophone start” with respect to the television responds to the special item, integrated server 100 provides control information corresponding to the “videophone start” for the “television 1”, to management server 200b for managing electric apparatus 400b represented as “television 1”.

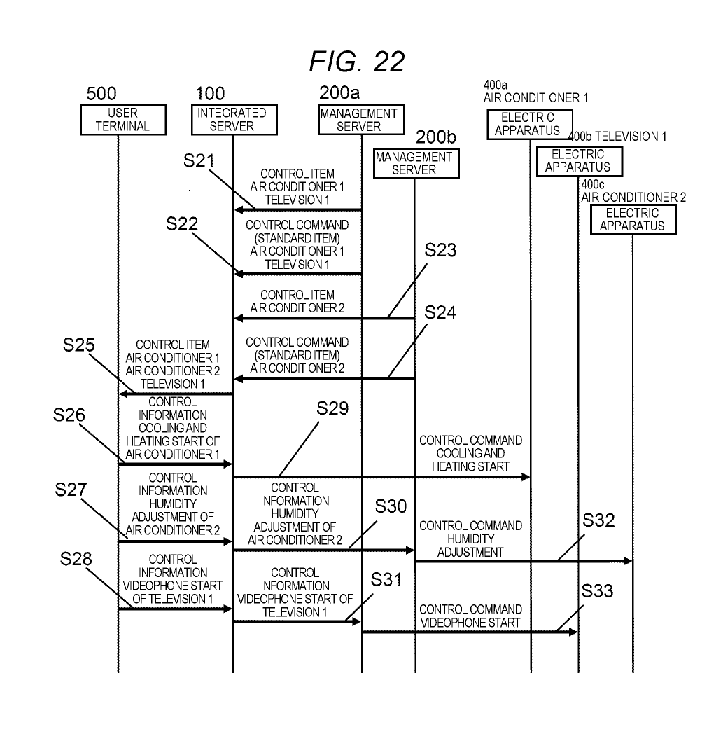

FIG. 22 is a diagram illustrating an example of a series of sequences for controlling electric apparatus 400, through integrated server 100 and management server 200, by using user terminal 500, in the second exemplary embodiment of the present invention.

Integrated server 100 obtains the control items of electric apparatuses 400 (400a, 400b, and 400c) and the control command corresponding to the standard items thereof, from management servers 200 (200a and 200b) (S21 to S24). Integrated server 100 provides the obtained control items to user terminal 500 (S25).

Integrated server 100 receives the control information from user terminal 500 (S26 to S28). In a case where the control items corresponding to the standard items are received, the control command corresponding to the received control information is provided to electric apparatus 400 (S29). Meanwhile, in a case where the control information corresponding to the special item is received, the control information is provided to management server 200 for managing electric apparatus 400 corresponding to the received control information (S30 and S31). Accordingly, management server 200 transmits the control command to electric apparatus 400 (S32 and S33). Then, a predetermined control is performed in electric apparatus 400.

As described above, according to the exemplary embodiment, since the control command relating to the standard items is provided to integrated server 100, it is possible for integrated server 100 to transmit the control command to electric apparatus 400, without going through management server 200. Meanwhile, since the control command relating to the special item is not provided to integrated server 100, it is possible to improve the safety of electric apparatus 400.

In the above-described embodiment, a scale and a shape of integrated server 100 are various, and for example, may be a shape such as that of the computer device to be installed within the house.

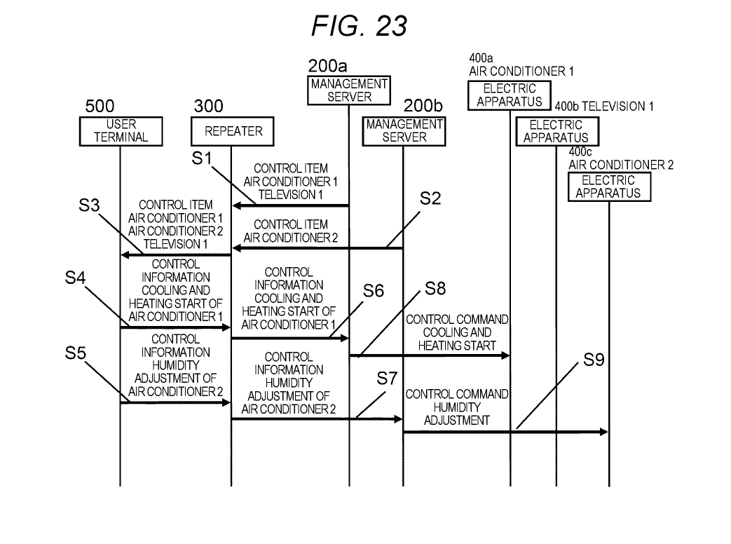

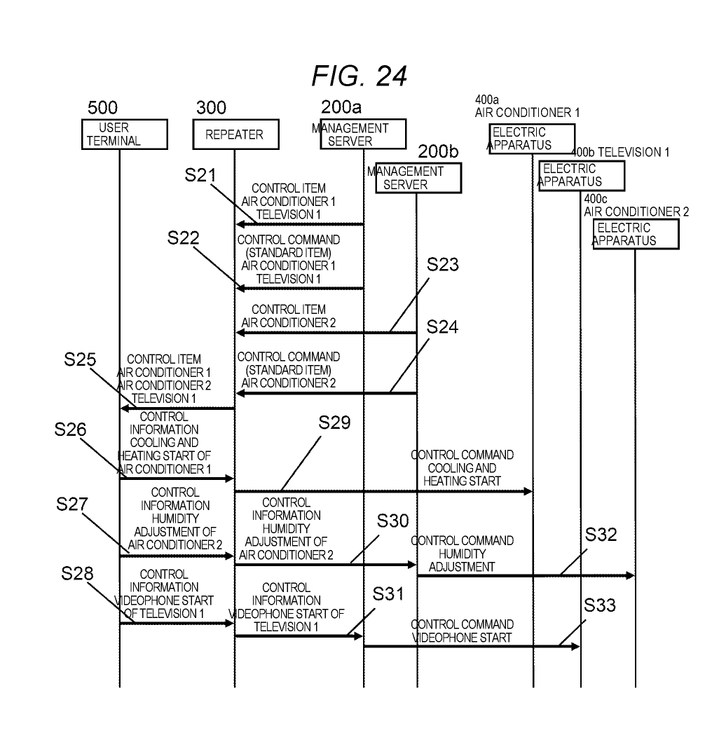

In addition, as illustrated in FIG. 23 and FIG. 24, in each exemplary embodiment, the processing performed in integrated server 100 may be performed in repeater 300, instead of integrated server 100.

FIG. 23 is a diagram illustrating an example of a series of sequences for controlling electric apparatus 400, through repeater 300 and management server 200, by using user terminal 500, in the first exemplary embodiment of the present invention. In addition, FIG. 24 is a diagram illustrating an example of a series of sequences for controlling electric apparatus 400, through repeater 300 and management server 200, by using user terminal 500, in the second exemplary embodiment of the present invention.

Even in any one of FIG. 23 and FIG. 24, a role as the management apparatus of integrated server 100 described above is performed by repeater 300.

In each exemplary embodiment, two management servers 200 are described. However, the present invention is not limited to this example. For example, even in a case of single management server 200 or three or more management servers 200, it is obvious the present invention can be applied.

### INDUSTRIAL APPLICABILITY

As described above, according to the present invention, the management server provides the control items, and does not provide at least a part of the control command to the management apparatus of the integrated server or the like. With this, it is possible to obtain exceptional effect that it is possible to improve the safety of the electric apparatus. Accordingly, the present invention can be applied to and used in the electric apparatus or the like that is separately managed by a plurality of management servers.

### REFERENCE MARKS IN THE DRAWINGS

100 integrated server
101 processor
102 memory
103 communicator
200, 200a, 200b management server
201 processor
202 memory
203 communicator
300 repeater
400, 400a, 400b, 400c, 400d electric apparatus
500 user terminal
501 processor
502 memory
503 communicator
504 input portion
505 output portion
800 control system

1. A method for managing an electric apparatus, comprising:
a step of obtaining first control item information for controlling a first electric apparatus, from a first management server that manages the first electric apparatus;
a step of obtaining second control item information for controlling a second electric apparatus, from a second management server that manages the second electric apparatus different from the first electric apparatus;
a step of providing information relating to the first control item information and the second control item information to a user terminal;
a step of receiving control information relating to the first electric apparatus and the second electric apparatus, from the user terminal; and
a step of transmitting the control item information corresponding to the control information received from the user terminal, of the first control item information and the second control item information, to any one of the first management server and the second management server in which the control item information is obtained.

2. The method for managing an electric apparatus of claim 1,
wherein the first control item includes a standard control item and a first special control item,
wherein the second control item includes the standard control item and a second special control item, and
wherein in a case where the control item information corresponding to the control information received from the user terminal is the standard control item, the method further comprises a step of transmitting a control signal corresponding to the control information, to the electric apparatus corresponding to the control item information, of the first electric apparatus and the second electric apparatus.

3. A method for managing an electric apparatus, comprising:
a step of obtaining first control item information for controlling a first electric apparatus, from a first management server that manages the first electric apparatus;
a step of providing information relating to the first control item information to a user terminal;
a step of receiving control information relating to control item information including the first control item information from the user terminal; and
a step of transmitting the control information to the first management server, in a case where a control item corresponding to the control information received from the user terminal is the first control item information, among the first control item information.

4. The method for managing an electric apparatus of claim 3,
wherein the first control item includes a standard control item and a first special control item, and
wherein in a case where the control item corresponding to the control information received from the user terminal is the standard control item, the method further comprises a step of transmitting a control signal corresponding to the control information, to the first electric apparatus.

5. A management apparatus comprising:
a communicator that obtains first control item information for controlling a first electric apparatus, from a first management server that manages the first electric apparatus, obtains second control item information for controlling a second electric apparatus, from a second management server that manages the second electric apparatus different from the first electric apparatus, provides information relating to the first control item information and the second control item information to a user terminal, and receives control information relating to the first electric apparatus and the second electric apparatus from the user terminal; and
a processor that controls the communicator, and selects control item information corresponding to the control information received from the user terminal, of the first control item information and the second control item information,
wherein the communicator transmits the control item information corresponding to the control information, to any one of the first management server and the second management server in which the control item information is obtained.

6. The management apparatus of claim 5,
wherein the first control item includes a standard control item and a first special control item,
wherein the second control item includes the standard control item and a second special control item, and
wherein in a case where the control item information corresponding to the control information received from the user terminal is the standard control item, the communicator transmits a control signal corresponding to the control information to the electric apparatus corresponding to the control item information of the first electric apparatus and the second electric apparatus.

7. A management apparatus comprising:
a communicator that obtains first control item information for controlling a first electric apparatus, from a first management server that manages the first electric apparatus, provides information relating to the first control item information to a user terminal, and receives control information relating to control item information including the first control item information from the user terminal; and
a controller that controls the communicator, and confirms whether a control item corresponding to the control information received from the user terminal is the first control item information, among the first control item information,
wherein in a case where the control item corresponding to the control information is the first control item information, the communicator transmits the control information to the first management server.

8. The management apparatus of claim 7,
wherein the first control item includes a standard control item and a first special control item, and
wherein in a case where the control item corresponding to the control information received from the user terminal is the standard control item, the communicator transmits a control signal corresponding to the control information to the first electric apparatus.

9. A program for managing an electric apparatus, causing a computer to execute:
a step of obtaining first control item information for controlling a first electric apparatus, from a first management server that manages the first electric apparatus;
a step of obtaining second control item information for controlling a second electric apparatus, from a second management server that manages the second electric apparatus different from the first electric apparatus;
a step of providing information relating to the first control item information and the second control item information to a user terminal;
a step of receiving control information relating to the first electric apparatus and the second electric apparatus, from the user terminal; and
a step of transmitting control item information corresponding to the control information received from the user terminal, of the first control item information and the second control item information, to any one of the first management server and the second management server in which the control item information is obtained.

10. The program for managing an electric apparatus of claim 9,
wherein the first control item includes a standard control item and a first special control item,
wherein the second control item includes the standard control item and a second special control item, and
wherein in a case where the control item information corresponding to the control information received from the user terminal is the standard control item, the program causes a computer to further execute a step of transmitting the control signal corresponding to the control information, to the electric apparatus corresponding to the control item information, of the first electric apparatus and the second electric apparatus.

11. A program for managing an electric apparatus causing a computer to execute:
a step of obtaining first control item information for controlling a first electric apparatus, from a first management server that manages the first electric apparatus;
a step of providing information relating to the first control item information to a user terminal;
a step of receiving control information relating to control item information including the first control item information from the user terminal; and
a step of transmitting the control information to the first management server, in a case where a control item corresponding to the control information received from the user terminal is the first control item information, among the first control item information.

12. The program for managing an electric apparatus of claim 11,
wherein the first control item includes a standard control item and a first special control item, and
wherein in a case where the control item corresponding to the control information received from the user terminal is the standard control item, the program causes a computer to further execute a step of transmitting a control signal corresponding to the control information, to the first electric apparatus.
